(19) United States
(12) Patent Application Publication
(10) Pub. No.: US 2014/0325812 A1
(43) Pub. Date: Nov. 6, 2014

(54) Brake Drum Remover and Remount Apparatus

(71) Applicants: Roger Nielson Wahlberg, Chamblee, GA (US); Paul Albert Martin, Brookhaven, GA (US)

(72) Inventors: Roger Nielson Wahlberg, Chamblee, GA (US); Paul Albert Martin, Brookhaven, GA (US)

(21) Appl. No.: 14/218,878

(22) Filed: Mar. 18, 2014

Related U.S. Application Data
(60) Provisional application No. 61/802,383, filed on Mar. 16, 2013.

(51) Int. Cl. B25B 27/02

(52) U.S. Cl. CPC B25B 27/023
USPC 29/426.5; 29/244; 29/258

(57) ABSTRACT

Brake drum remover and remount apparatus having attachment members adapted to be captured by a rigid bar with handles and to engage the front peripheral surface of a brake drum member to allow a wobble axial pull action resulting in separation of brake drum from the brake drum mating member and or alternatively allow an axial forced separation by rotational action of attachment members through brake drum exerting axial separating force action on the peripheral surface of the brake drum mating member resulting in separation of brake drum from the brake drum mating member. Additionally Brake drum remover and remount apparatus can be utilized using a wobble axial push action for remounting of the brake drum to the drum mating member

Claim Benefit of Provisional Application No. 61/802,383

### BACKGROUND OF THE INVENTION

The field of this invention relates to drum brake tools for the auto technician. The Brake drum removal can present problems due to rusted brake drum inner surfaces adhering to rusted mating hub surfaces, rusted central hole surfaces of the drum adhering to mating rusted outer diameter hub surfaces, tightly adjusted brake shoes rubbing against mating inner diameter drum surfaces, or worn ridges and lips in inner diameter surfaces of drums catching on brake shoes assemblies nested within the brake drums attached to plates of the suspension members thus making drum removal often very difficult and time consuming for the technician. Often a combination of these conditions make even more difficult.

Present brake drum removal methods use either a heavy jarring action with a hammer on the drum, a static jaw puller action, prying methodologies, a pressure point adaptors at various gripping points and fulcrum points, or with various other methods of exerting static and dynamic forces and impulses on the drum member mounted to the hub—forces that can be used to cause the separation of the drum and mating hub members.

Present methods can be expensive, time consuming, complex with numerous members and mechanisms, dangerous and physically damaging to the apparatus operator, damaging to drum, damaging to brake shoe assembly parts, and damaging to hub member parts, and can be inefficient, unpredictable, and often ineffective in removal of drum from mating hub.

This Brake Drum Remover and Remount Apparatus provides a safe, quick and predictable method to remove the most difficult stuck drums and to easily and quickly remount a drum to a serviced and tightly readjusted hub and brake shoe assembly.

### BRIEF SUMMARY OF THE INVENTION

The present invention is a multi operational brake drum removal apparatus used for the quick, simple, and sure brake drum removal from a mating hub safely and without member damage and for the quick and easy remounting of a brake drum after brake servicing. The structure of various embodiments of this invention is shown in the figures.

### BRIEF DESCRIPTION OF THE DRAWINGS

FIG. 1 shows Brake Drum Remover and Remount Apparatus Prototype Working drawing

FIG. 2 illustrates side view of one embodiment for Pull off action.

FIG. 3 presents side view of another embodiment for Force off action

FIG. 4 presents detail view of rotational component

FIG. 5 illustrates side view of an alternate embodiment for Pull off action with Slide hammer arrangement.

FIG. 6 illustrates side view of an alternate embodiment for Force off action speed wrench arrangement.

FIG. 7 illustrates side view of an alternate embodiment for Force off action single point input gear arrangement

FIG. 8 illustrates Typical Brake Drum with threaded holes

FIG. 9 illustrates photo of Actual Prototype Brake Drum Remover and Remount Apparatus on Brake Drum

FIG. 10 illustrates photo of Actual Prototype Brake Drum Remover and Remount Apparatus on Brake Drum

FIG. 11 illustrates Three Dimensional Digital Drawing of Brake Drum Remover and Remount Apparatus on Brake Drum

### DETAILED DESCRIPTION AND BEST MODE OF IMPLEMENTATION

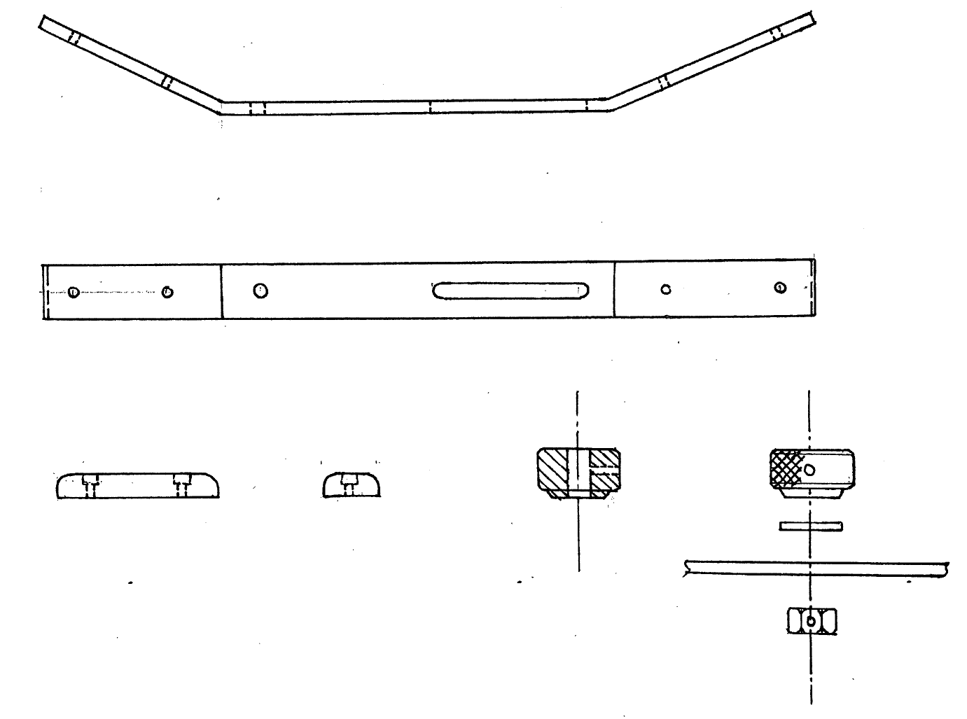

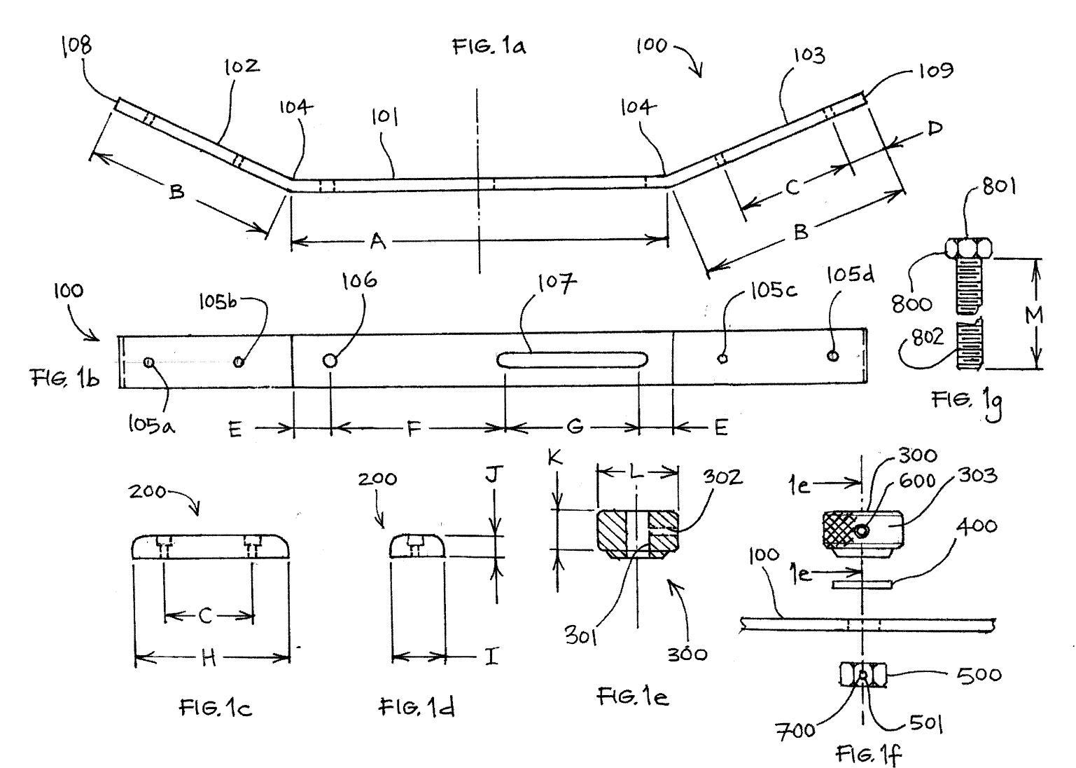

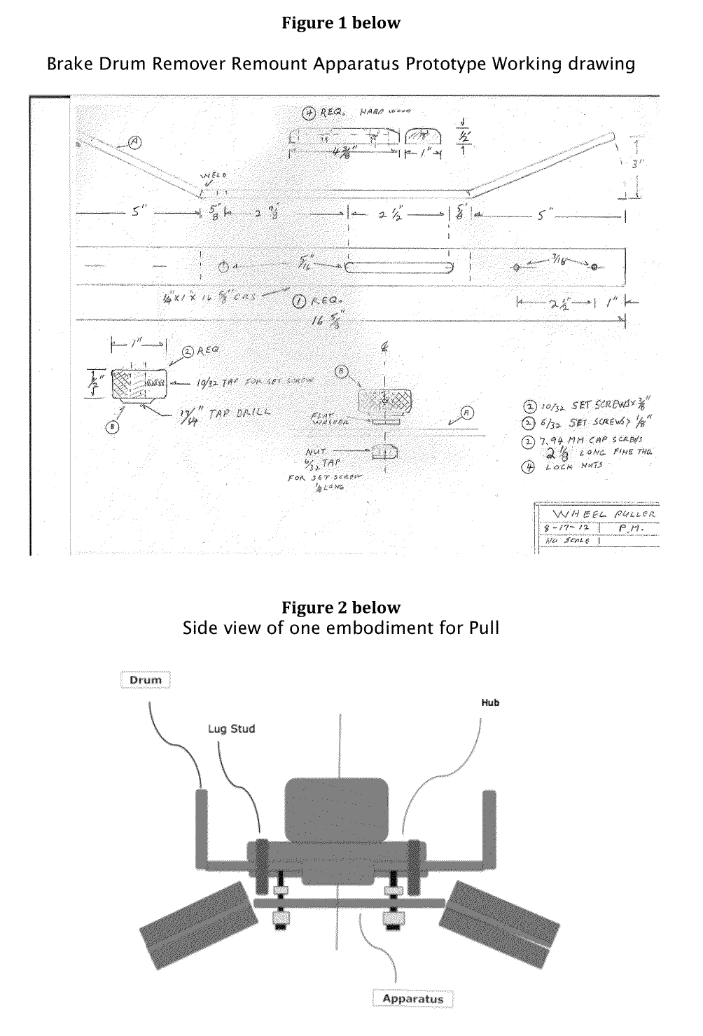

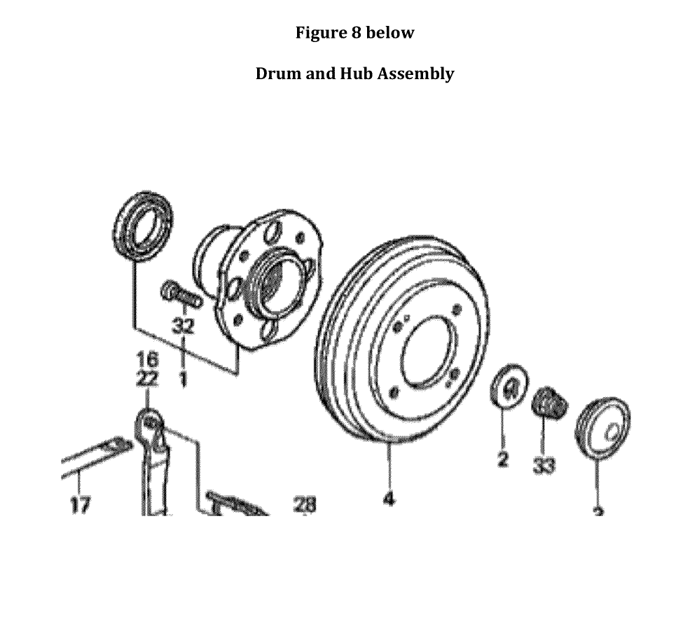

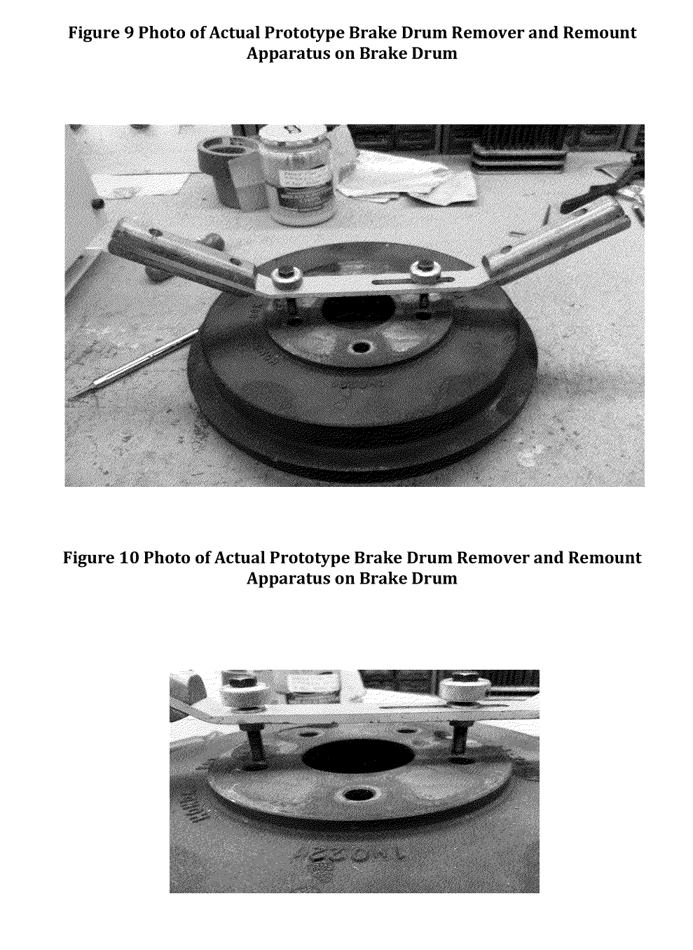

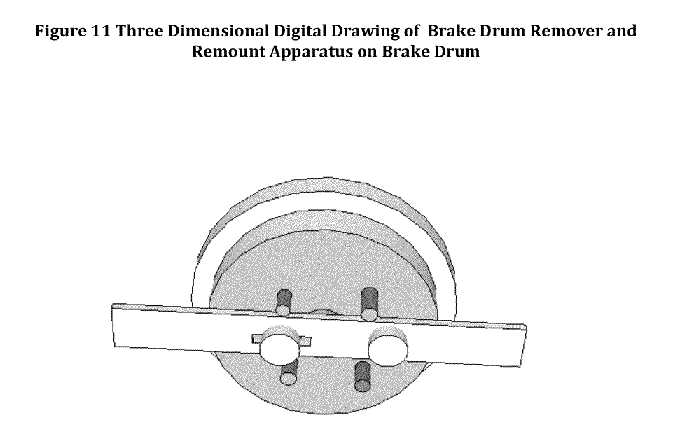

The Brake Drum removal apparatus with attachment members is connected to the front peripheral surface of the drum FIG. 2 that is to be separated from the mating hub member with the attachment members engaging threaded holes inherent in compatible manufactured drums FIG. 8. A rigid bar with handles suitable for the apparatus operator having a preferred length of 50 to 70 cm and of suitable shape to axially retain the attachment members FIG. 4 and to allow the axial pull removal of the drum FIG. 2 with or without an alternating pull motion on the ends of the apparatus bar resulting in the separation of the brake drum member from the brake drum mating member. See FIG. 1

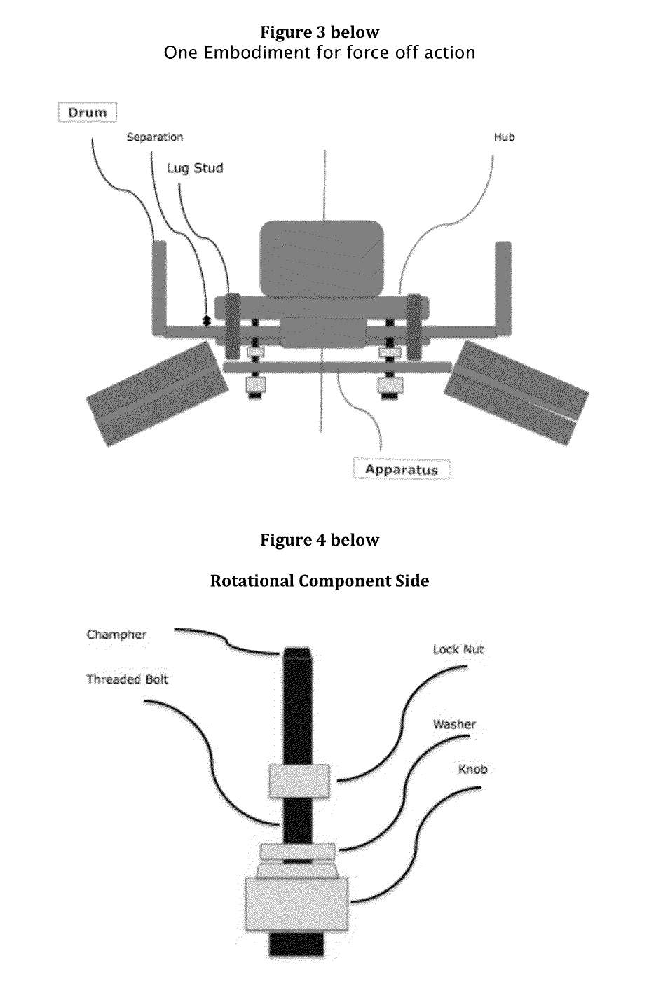

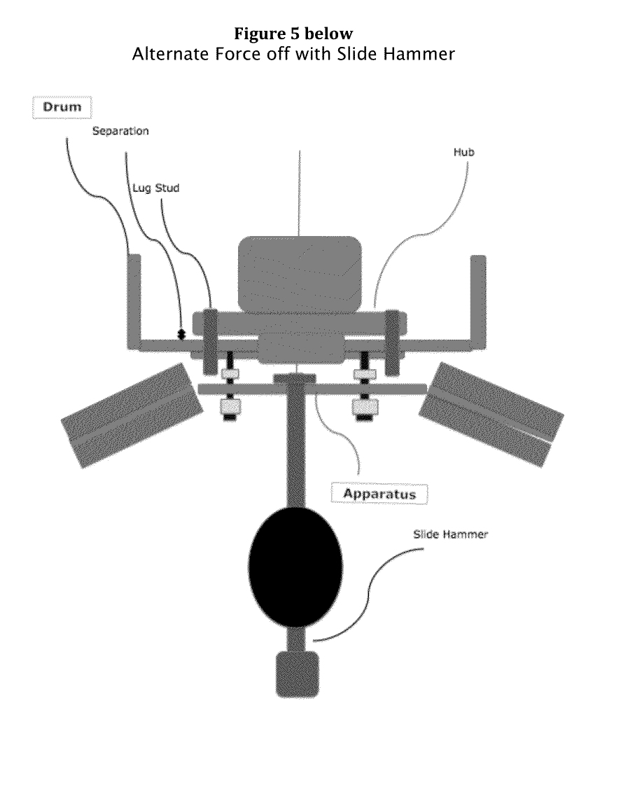

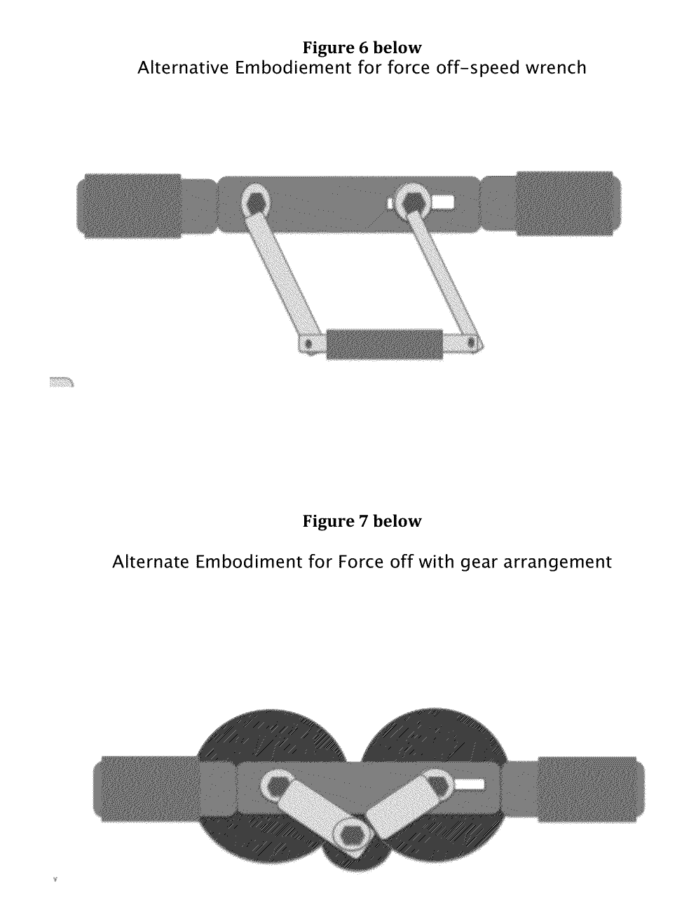

Secondarily the apparatus can be used to cause a static forced separation of the brake drum from the brake drum mating member by alternating yet incremental rotational adjustments of attachment members thus applying axial forces against the brake drum mating member peripheral surface resulting in the same said axial separation of the two members as above. FIG. 3

I claim:

1. The Brake Drum Remover and Re Mount Apparatus will remove a stuck brake drum to the brake hub assembly and the companion brake shoe assembly by an alternating axial pull operation (wobbling) exerted on the handle members of the apparatus until the drum is incrementally but completely removed from the mating hub and shoe assemblies.

2. The Brake Drum Remover and Re Mount Apparatus will remove a stuck brake drum to the brake hub assembly and the companion brake shoe assembly by a forced separation using screw members alternatively adjusted exerting separating forces between the brake hub assembly and the companion brake shoe assembly until the drum is incrementally but completely removed from the mating hub and shoe assemblies.

3. The Brake Drum Remover and Re Mount Apparatus of claim 1 wherein Apparatus will remount a brake drum to the brake hub assembly and the companion brake shoe assembly by an alternating axial pressing operation (wobbling) exerted on the handle members of the apparatus until the drum is incrementally but completely remounted on the mating hub assembly and over the shoe assembly.

4. The Brake Drum Remover and Re Mount Apparatus of claim 1 wherein a method for removing a stuck brake drum from the brake hub assembly and the companion brake shoe assembly by an alternating axial pull operation (wobbling) exerted on the handle members of the apparatus until the drum is incrementally but completely removed from the mating hub and shoe assemblies.

5. The Brake Drum Remover and Re Mount Apparatus of claim 2 wherein an Apparatus for removing a a stuck brake drum from the brake hub assembly and the companion brake shoe assembly by a forced separation using screw members alternatively adjusted exerting separating forces between the brake hub assembly and the companion brake shoe assembly until the drum is incrementally but completely removed from the mating hub and shoe assemblies.

6. The Brake Drum Remover and Re Mount Apparatus of claim 2 wherein an Method for removing a a stuck brake drum from the brake hub assembly and the companion brake shoe assembly by a forced separation using screw members alternatively adjusted exerting separating forces between the brake hub assembly and the companion brake shoe assembly until the drum is incrementally but completely removed from the mating hub and shoe assemblies.
